(19) United States
(12) Patent Application Publication
(10) Pub. No.: US 2002/0187452 A1
(43) Pub. Date: Dec. 12, 2002

(54) Orthodontic bracket

(76) Inventors: Norbert Abels, Homburg (DE); Claus H. Backes, Saarbrucken (DE)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/914,737

(22) PCT Filed: Jul. 23, 2001
(86) PCT No.: PCT/EP01/08189

(30) Foreign Application Priority Data
Jul. 24, 2000 (DE) 10035992.2

(51) Int. Cl. A61C 3/00

(52) U.S. Cl. 433/11

(57) ABSTRACT

An orthodontic bracket has a base on which a covering is attached in an articulated manner, while the covering covers a slot for an arch wire. The covering and the base are connected to one another in an articulated manner. Spring elements are provided for holding the arch wire.

The present invention relates to an orthodontic bracket with a base on which a covering is attached in an articulated manner, which covers a slot for an arch wire.

Such brackets are generally known from prior art (see U.S. Pat. No. 4,712,999).

The task of the invention is to further develop an orthodontic bracket of the kind mentioned at the start in such a way as to enable inexpensive and easy manufacture, a compact construction method, and simplified handling.

The solution of this problem is provided by the features of claim 1, and in particular by the fact that the covering and the base are connected to one another in one piece, that a first spring element is provided on the underside of the covering, which protrudes into the slot when the covering is closed, thus exerting a clamping force on an arch wire inserted in the slot, and that several catch depressions or retaining catches are provided on the covering or on the base.

Inexpensive and simple manufacturing is guaranteed by the fact that the covering and the base are connected with one another in one piece, since only one component exists, which does not have to be put together, and only one material is used, preferably plastic. In addition, the covering is attached to the base in such a way that it cannot be lost. Furthermore, because of the elastic spring element provided on the underside of the covering in the invention, an improved hold of the arch wire within the slot is provided, while in particular, even when the covering is not yet closed or locked, there is already a fixing of the arch wire within the slot. In the invention, in contrast to the solution known from the prior art mentioned in the beginning, on the one hand, a spring element arranged within the slot is provided, which does not protrude laterally outside the outer contours of the bracket. And on the other hand, a separate elastic spring element is provided for holding the arch wire, the spring force of which can be selected, that is, the flexibility of the covering is not used for holding the arch wire.

The inventive bracket is further designed in a self-ligating manner, that is, the arch wire is clamped between the covering and the base. Since several catch depressions or retaining catches are provided on the covering and/or on the base, the covering can be closed at various distances. Thus arch wires of varying diameters can be inserted into the slot and fixed there with the help of the first spring element by closing the covering. At the same time, this makes it possible to vary the ligating force on the arch wire during adjustment of the arch wire.

Advantageous embodiments are described in the description, the subclaims, and the figures.

According to an initial advantageous embodiment, a second spring element is provided on the bracket, which supports the closing and opening movement of the covering. This guarantees that the covering is held by the spring element in the open position, so that the opened covering does not get in the way of inserting the arch wire. At the same time, the covering can be pressed into the closed position with a spring force by the second spring element, so that during adjustment of the arch wire in the slot, the covering is held closed by a spring force and thus presses the arch wire into the slot through the first spring element. Meanwhile, it is preferable if the second spring element presses the covering into the closed position with a spring force, which is approximately 50% to 90%, in particular approximately 70%, of the maximum spring force. This guarantees that the covering is pressed into the closed position with sufficient spring force that the arch wire does not inadvertently slide out of the slot during adjustment.

Preferably the first spring element is designed in one piece as a molded-on tongue on the underside of the covering, which preferably extends along the entire length of the slot. On the one hand, this enables the holding force of the first spring element to be set as desired. And on the other hand, it provides a secure hold on the arch wire along the entire length of the slot.

According to another advantageous embodiment, the first spring element is swung into the slot around an axis, the distance of which to the catch depressions or retaining catches provided on the covering is greater by a factor of 2 to 3.5 than its distance to the first spring element. In other words, this means that in such an embodiment very good leverage ratios exist, since the lever arm between the first spring element and the swing axis is relatively small, while, on the other hand, the lever arm between this swing axis and the catch depressions or retaining catches, in the area of which the closing pressure on the covering is applied, is relatively large. This allows a large force to be applied in the area of the first spring element with a small closing pressure, so that the arch wire is held especially firmly in the slot. In particular, since several catch noses and catch depressions are provided, the holding force with which the arch wire is held in the slot can be set by closing the covering more or less tightly. For example, it is possible to place the covering in its first catch position for adjusting the arch wire. After adjustment and setting, then, the covering can be closed further, so that the arch wire is finally fixed and held in its desired position.

According to another advantageous embodiment, a joint between covering and base is provided on the upper side of the base, preferably between the slot and the external contour of the base. On the one hand, favorable leverage ratios result for this embodiment. On the other hand, by varying the hinge point in the area between the slot and the outer contour of the base, the holding force for the arch wire within the slot can be varied. In another advantageous embodiment, an additional joint can be arranged between covering and base on the outer side of the base, preferably at about half the height between the upper side and lower side of the base. In this embodiment, the covering is fastened to the base by means of two joints, with one part of the covering acting as a second spring element, which exerts an opening and closing force on the covering. In this embodiment it is possible, by varying the linkage points, to vary and set both the closing pressure acting on the arch wire and the opening angle of the covering in the open state. Thus it is possible in a simple manner to provide inventive brackets with different opening angles for different tooth positions, which makes handling and inserting the arch wire considerably easier.

According to another design of the invention, a second slot is provided on the base for another arch wire, which creates the possibility of inserting a second bending wire for corrective measures. Meanwhile, the second slot is preferably likewise covered by the covering, so that a pleasant wearing sensation is created and the lodging of food residues in the bracket area is minimized. To the extent that the two slots open in directions which include an angle of approximately 90° with one another, corrective measures can be effected in a very favorable manner. In another advantageous embodiment, at least one relief is provided on the base in an area not covered by the covering. This makes it possible to apply or mount fixing means like elastomer rings, for example, or additional aids for the correction of faulty positioning, without having to open the covering.

Preferably the second spring element is connected in one piece with the base and the covering. It is preferable, furthermore, if the spring element is connected to the base and the covering by means of joints, which are preferably formed by reducing the material cross sections in the area of the joint. This results in a compact design of the bracket despite the provision of the spring element. Inexpensive manufacturing is guaranteed by the possibility of manufacturing the bracket in one piece, for example, as a plastic injection molded piece.

According to another embodiment, the joint between the base and the covering can be formed by reducing the material cross sections in the area of the joint. By the use of such hinges, which are also known as film hinges, the bracket can be designed in a compact manner.

It is especially advantageous if the spring element is fully integrated into the covering when the covering is closed, so that the bracket has no protruding parts or edges when closed. This very significantly increases the comfort of the wearer, since there are no edges which might irritate the mouth of the patient.

According to another advantageous embodiment, a reinforcement insert is provided on the base in the area of the slot; the insert is preferably manufactured of metallic material. Such a reinforcement insert can be worked into the base material of the bracket in the manufacturing process, for example, by injection molding around it with plastic. This ensures that the forces acting in the area of the arch wire are transmitted without losses onto the base and thus onto the tooth which is to be corrected. At the same time, the manufacturing costs are further reduced here as well, since the bracket as a whole can be manufactured out of plastic and only the reinforcement piece is manufactured of hard material, for example metal.

It is preferable that the covering covers the base along its entire external contour. This ensures that no contaminants (food residues) can get into the inside of the bracket. Meanwhile, by means of a smooth, particularly a kidney-like shaping of the covering, the comfort of the wearer can be significantly increased.

According to another advantageous embodiment, the retaining catches and/or catch depressions have a cross section shaped approximately like saw teeth. This ensures that the cover will not inadvertently open, for example, from food residue getting stuck in it. Rather, in this embodiment, the covering can be opened only with the aid of a tool, which removes the retaining catch and catch depressions from engaging.

According to another aspect of the present invention, it includes an orthodontic bracket set, which includes at least one bracket of the kind mentioned above as well as a second, separate covering. This second covering does not have a molded-on spring element, but rather it has catch elements for fastening onto the base, so that this second covering can be set onto the base as an alternative to the covering which is solidly connected to the base, after the covering mentioned first has been separated from the base, for example by a scalpel. Such a bracket set makes it possible, for example under limited space conditions, to separate the covering originally provided and to replace this covering with a separate covering which is merely pressed on to the base.

In the following, the present invention is described using exemplary embodiments with reference to the enclosed drawings.

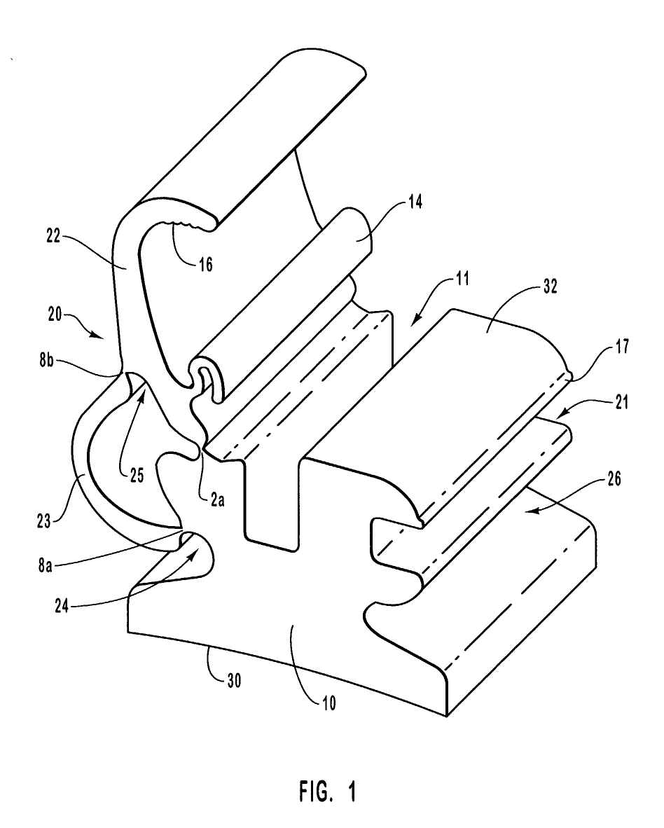

FIG. 1 shows a perspective view of an orthodontic bracket with the covering open.

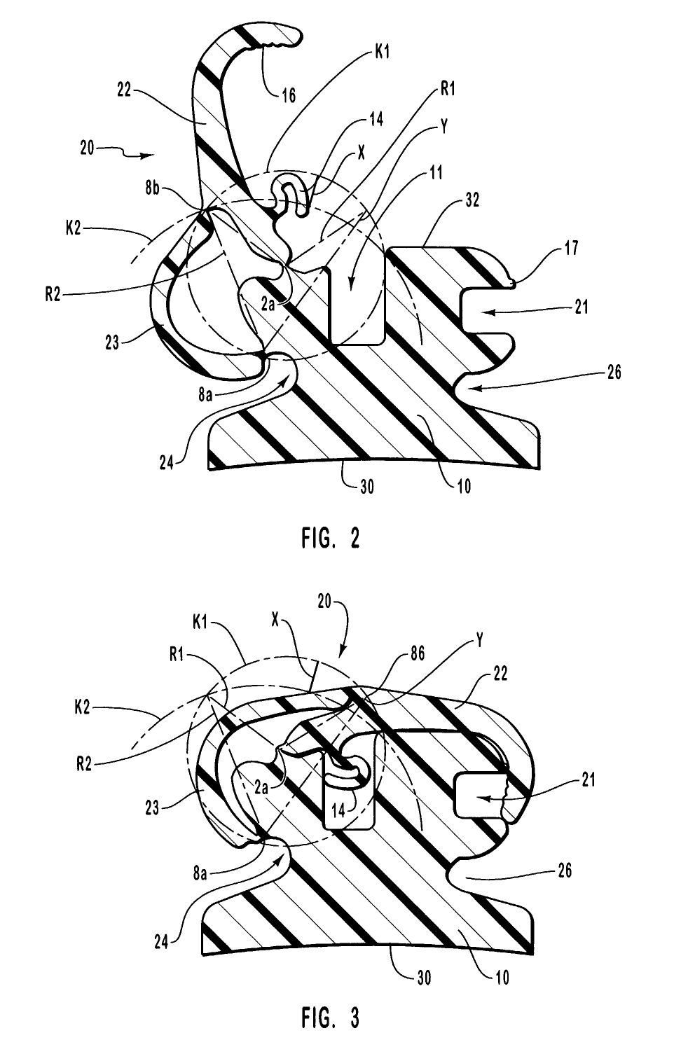

FIG. 2 shows a side view of the bracket of FIG. 1 with the covering open.

FIG. 3 shows a side view of the bracket of FIG. 1 with the covering completely closed.

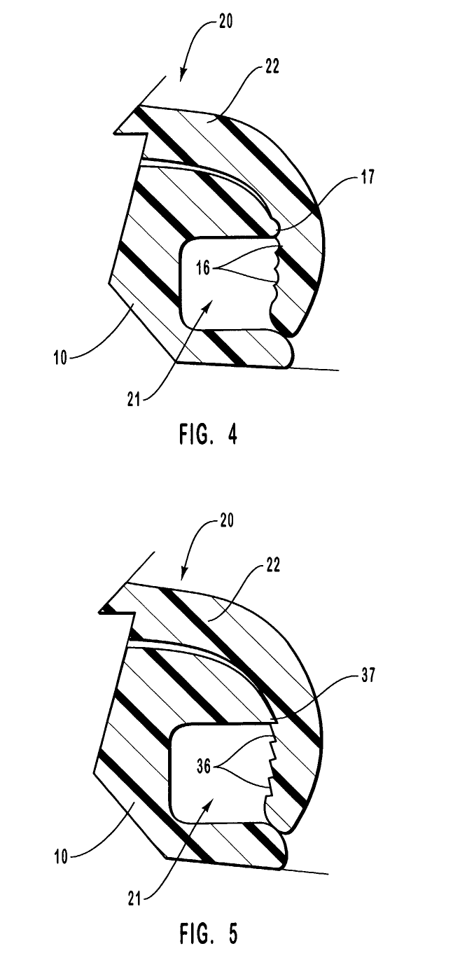

FIG. 4 shows an enlarged section view of the bracket of FIG. 1 with the covering closed, and

FIG. 5 shows an enlarged section view of an alternative embodiment of a bracket with the covering closed.

The orthodontic bracket shown in FIGS. 1 to 4 is manufactured in one piece as a plastic injection molded piece, and it has a base (10), which in cross section is shaped approximately like an anvil, to which a covering (20) is fastened in an articulated manner. In the center of base (10) a slot (11) is provided which is open toward the upper side of base (10) and serves for threading an arch wire (not shown). In the area of slot (11) a reinforcement insert (not shown) is provided which is made of metallic material and is approximately U-shaped in cross section. The bracket base material is injection-molded around reinforcement insert (13) [sic] in the manufacturing process. The arch wire, which is rectangular in cross-section and serves to correct the teeth in a generally known manner, is arranged inside slot (11).

Covering (20) forms a hood, approximately kidney-shaped in cross section, and is connected in one piece to base (10) by means of a first film hinge (2a). A spring element (23), curved approximately like an arc in cross section, which forms part of covering (20), is attached to base (10) in an articulated manner by means of a joint (8a), namely by means of a film hinge, which is designed during injection molding in the same way as film hinge (2a) by a corresponding reduction of the material cross sections in the area of the joint. Meanwhile, joint (8a) is located approximately halfway up base (10) between its bottom (30) and its upper side (32). In addition, spring element (23) is attached to the external side of covering (20) in an articulated manner by means of another, identically designed film hinge (8b) at about the middle of covering (20). All of the film hinges (2a), (8a), and (8b) extend across the entire width of bracket base (10).

As FIG. 3 shows in particular, spring element (23) is fully integrated into covering (20), so that spring element (23) together with a cover piece (22) of covering (20) forms a hood-like, kidney-shaped protective shell. For the integration of spring (23) into cover piece (22), a depression (25) (FIG. 1) is provided on the upper side of cover piece (22), into which spring element (23) is so completely taken up when covering (20) is closed that the upper side of cover piece (22) and spring element (23) form one uniform, continuous surface.

A plurality of catch depressions (16) are provided on the inside of covering (20), by means of which covering (20) can catch onto a retaining catch (17) which is molded onto an outer edge of base (10). As FIG. 4 shows in particular, both retaining catch (17) and the five catch depressions (16) have an approximately circle-segment-shaped cross section.

In addition, a spring element in the form of a tongue (14) with a U-shape in cross section is provided in the middle of covering (20) on its inner side, which in the closed state (FIG. 3) fixes the arch wire in slot (11). The fixing is performed merely by the closing of covering (20) and the catching of a catch depression (16) on retaining catch (17), that is, the bracket is self-ligating and its holding force can be set by closing covering (20) at different levels, while the holding force is applied by spring element (14) and not by any deflection of covering (20).

As FIGS. 2 and 3 in particular make clear, film hinge (8b), which serves as a joint, moves along an arc K1 of radius R1 during opening and closing of covering (20). If spring element (23) were not connected with covering (20) in the area of joint (8b), then the free end of spring element (23), when rotated around the axis of film hinge (8a), would move on an arc K2 of radius R2. As a result of its being fixed on cover piece (22) in the area of joint (8b), however, it is forced to move on arc K1 with radius R1. In this way, spring element (23) is elastically distorted during opening and closing, with the maximum elongation X being preferably attained at about the halfway opening or closing angle. In this way, the spring force of spring element (23) above and below this angle supports the opening and closing process of covering (20) in either direction. When this angle is passed through, spring element (23) is stretched by the maximum path X.

As FIGS. 2 and 3 also show, the kinematics of the overall system in the depicted bracket were selected in such a way that the spring force when covering (20) is closed does not go to zero, but rather drops only to a value of approximately 70% of the maximum spring force acting on covering (20). As FIG. 3 shows, even in the completely closed and completely locked position of covering (20), a spring force still acts on covering (20) (stretch by the path Y), which then acts, due to the leverage ratios prescribed in the design, by means of tongue (14) on the arch wire in slot (11). Due to the elasticity of tongue (14) and the additional form-fitting locking ability of covering (20) onto base (10) through the provided catch depressions (16) and retaining catch (17), the pressure exerted on the arch wire can be increased beyond the closure achieved by spring element (23) by further pressing of the covering.

As FIGS. 2 and 3 also show, first spring element (14) is swung around axis (2a), the distance of which to catch depressions (16), in the area of which the closing pressure is applied, is greater by a factor of 2 to 3.5 than its distance to first spring element (14). This results in very favorable leverage ratios during the closing of covering (20).

As FIGS. 1 to 3 also show, an additional slot (21) is provided on an external side of base (10) for another arch wire, which runs parallel to slot (11), but opens in a direction which is displaced by 90° from the opening direction of slot (11). This means that slot (11) opens toward the upper side of the base and slot (21) opens toward the front side of the base. Like slot (11), slot (21) also has a rectangular cross section, and a metal reinforcement insert can also be provided in the area of slot (21). As FIG. 3 shows in particular, slot (21) is completely covered by covering (20) when covering (20) is fully closed and fully locked.

As FIGS. 1 to 3 also show, recesses (24, 26) are also provided on base (10) running parallel to slots (11) and (21), which extend across the entire width of base (10), and which, with their undercutting, enable the secure fixing of elastomer rings or other fixing or helping means for correcting a false positioning. When covering (20) is closed, recesses (24) and (26) are located directly below the lower edge of covering (20).

FIG. 5 shows an alternative embodiment of a catch mechanism. In this variant, several (a total of five) catch depressions are provided on the inside of covering (20), which have a saw-toothed cross section and can be used to catch covering (20) at different position on a likewise saw-tooth-shaped retaining catch (37), which is molded onto an outer edge of base (10).

List of Reference Symbols

| | |
|---|---|
| 2a | Film hinge |
| 8a, 8b | Film hinge |
| 10 | Base |
| 11 | Slot |
| 14 | First spring element |
| 16 | Catch depression |
| 17 | Retaining catch |
| 20 | Covering |
| 21 | Slot |
| 22 | Cover piece |
| 23 | Spring element |
| 24 | Recess |
| 25 | Depression |
| 26 | Recess |
| 30 | Bottom |
| 36 | Catch depression |
| 37 | Retaining catch |
| K1, K2 | Arc |
| R1, R2 | Radii |
| X | Maximum elongation |
| Y | Elongation |

1. Orthodontic bracket with a base (10) on which a covering (20) is attached in an articulated manner, which covers a slot (11) for an arch wire, characterized in that
covering (20) and base (10) are connected to one another in one piece,
that a first spring element (14) is provided on the underside of covering (20), which protrudes into slot (11) when covering (20) is closed, thus exerting a clamping force on an arch wire inserted in slot (11), and
that several catch depressions (16, 36) or retaining catches (17, 37) are provided on covering (20) or on base (10).

2. Orthodontic bracket of claim 1, characterized in that
a second spring element (23) is provided, which supports the closing and opening movement of covering (20), with second spring element (23) pressing covering (20) into the closed position with a holding force which is preferably about 50% -90%, in particular about 70%, of the maximum spring force.

3. Orthodontic bracket of claim 1, characterized in that
the first spring element is designed in one piece as a molded-on tongue (14) on the underside of covering (20), which preferably extends along the entire length of slot (11).

4. Orthodontic bracket of claim 1, characterized in that
first spring element (14) is swung around an axis (2a), the distance of which to catch depressions (16) or to the retaining catches provided on covering (20) is greater by a factor of 2 to 3.5 than its distance to first spring element (14).

5. Orthodontic bracket of claim 1, characterized in that a joint (2a) between covering (20) and base (10) is provided on the upper side of base (10), preferably between slot (11) and the external contour of base (10).

6. Orthodontic bracket of claim 1, characterized in that
a joint (8a) is arranged between covering (20) and base (10) on the outside of base (10), approximately halfway up between the bottom and the upper side of base (10).

7. Orthodontic bracket of claim 1, characterized in that
a second slot (21) is provided on base (10) for another arch wire, which is preferably likewise covered at least partially by covering (20).

8. Orthodontic bracket of claim 7, characterized in that
the two slots (11, 21) open in directions that include an angle of approximately 90° with one another.

9. Orthodontic bracket of any of the preceding claims, characterized in that
at least one relief (24, 26) is provided on base (10) in an area not covered by covering (20).

10. Orthodontic bracket of any of the preceding claims, characterized in that
a second spring element (23) is provided, which supports the closing and opening movement of covering (20), while preferably second spring element (23) is connected in one piece with base (10) and covering (20).

11. Orthodontic bracket of claim 10, characterized in that
second spring element (23) forms a part of covering (20).

12. Orthodontic bracket of claim 10 or 11, characterized in that
second spring element (23) is connected to base (10) and covering (20) by means of joints (8a, 8b), which are preferably formed by reducing the material cross sections in the area of the joint.

13. Orthodontic bracket of any of the preceding claims, characterized in that
a joint (2a, 8a) between covering (20) and base (10) is formed by reducing the material cross sections in the area of the joint.

14. Orthodontic bracket of any of the preceding claims, characterized in that
catch depressions (36) and/or retaining catches (37) are designed with an approximately saw-toothed shape in cross section.
